(19) United States
(12) Patent Application Publication
(10) Pub. No.: US 2025/0384116 A1
(43) Pub. Date: Dec. 18, 2025

(54) Method and System for Authenticating a User Via Face Recognition

(71) Applicant: Biocube Technologies Inc., Dover, DE (US)

(72) Inventors: Subodh Narain Agrawal, London (GB); Anil Kumar Sharma, Hillingdon (GB); Ashutosh Agarwal, Gurgaon (IN); Bharat Pruthi, Jind (IN); Sankalp Varshney, Hathras (IN)

(21) Appl. No.: 19/107,923

(22) PCT Filed: Sep. 2, 2023
(86) PCT No.: PCT/IB2023/058698

§ 371 Date: Feb. 28, 2025

(30) Foreign Application Priority Data
Sep. 2, 2022 (IN) 202211050310

(51) Int. Cl. G06F 21/32; G06V 40/16; G06V 40/40

(52) U.S. Cl. CPC G06F 21/32; G06V 40/172; G06V 40/45

(57) ABSTRACT

The present disclosure relates to a method and a system for authenticating a user via face recognition. The disclosure encompasses: capturing at least one image(s) of the user; analyzing the at least one captured image(s) of the user to detect a face corresponding to the pre-defined parameters being conformed; cropping out the detected face from the at least one captured image to form a cropped face image; extracting one or more features from the cropped face image; comparing the extracted one or more features with a set of data associated with a plurality of users, and authenticating the user based on a positive matching of the extracted one or more features of the cropped face image with the set of data corresponding to the user.

### TECHNICAL FIELD

The present disclosure generally relates to the field of facial recognition technology, and more particularly to a method and a system for authenticating a user via face recognition in one or more edge devices that supports interoperability such that plurality of users can be registered on one platform/edge device and get authenticated on other platforms/edge devices.

### BACKGROUND

This section is intended to provide information relating to the technical field and thus, any approach or functionality described below should not be assumed to be qualified as prior art merely by its inclusion in this section.

A facial recognition system is a technology capable of matching a human face from a digital image or a video frame against a database of faces, typically employed to authenticate users through ID verification services. The various use cases of the facial recognition system include, but not limited to, access and attendance, payment gateway, criminal recognition, de-duplication, and identity verification. Face detection also refers to the psychological process by which humans locate and attend to faces in a visual scene.

The existing solutions for the facial recognition system generate an encoding on a server during authentication time such that the process of authentication happens on the server. In such scenarios, an edge device captures an image of a user and sends the captured image to the server to perform the process of authentication. The speed at which this solution works is dependent on the network connectivity and is time consuming in case of low network connectivity. Further, in such solutions, the facial recognition system does not work if the system is offline. In another other existing solution, encoding for recognizing face is generated on both server and edge devices, but said encoding is different which does not allow the solution to be inter-operably used on the server as well as the edge device. In yet another solution where Deep convolutional neural networks (DNNs) are used for the facing recognition system, a system training is required to allow facial recognition system to work efficiently. However, doing such system training requires a lot of computational power which is not possible to achieve using edge devices such as smartphones. So, in order to perform system training, outsourcing of training is done which can lead to violation of privacy of the registered users. Furthermore, in the existing solutions, DNN models need to be trained for face recognition. One of the ways used to train the DNN models. It is done by utilizing multi-class classifier which can separate different identities in the training set, such by using a SoftMax classifier and those that learn directly use an embedding, such as the triplet loss. Based on the large-scale training data and the elaborate DNN architectures, both the SoftMax-loss-based methods and the triplet-loss-based methods can obtain excellent performance on face recognition. However, both the SoftMax loss and the triplet loss have some drawbacks.

The conventionally available system and method fail to solve the problem of interoperability of the facial recognition system between two or more edge devices. Further, existing solutions do not provide a solution for the facial recognition system to address the challenge of working in offline mode due to network and server dependency. Further, the conventionally available systems violate privacy of the registered users because it exposes the users' data to curious service providers.

Hence, in view of these and other existing limitations, there arises an imperative need to provide an efficient solution to overcome the above-mentioned limitations. The present invention proposes a novel approach of removing server dependency, network dependency, reducing cost, ensuring interoperability in facial recognition system even in case when the system is in an offline mode.

### SUMMARY

This section is provided to introduce certain aspects of the present disclosure in a simplified form that are further described below in the detailed description. This summary is not intended to identify the key features or the scope of the claimed subject matter.

In an aspect, the present disclosure provides a method for authenticating the user via face recognition. The method comprises: capturing, by an image capturing unit, at least one image of the user. Further, the method encompasses analyzing, by an analyzer module, the at least one captured image(s) of the user to detect a face corresponding to the pre-defined parameters being conformed. Thereafter, the method encompasses cropping out, by a cropping module, the detected face from the at least one captured image to form a cropped face image. Furthermore, the method encompasses extracting, by an extraction module, one or more features from the cropped face image. Thereafter, the method [200] encompasses comparing, by a comparison module, the extracted one or more features of the cropped face image with a set of data associated with a plurality of users, wherein the set of data associated with the plurality of users is stored in the one or more database repositories. Lastly, the method encompasses authenticating, by an authentication module, the user based on a positive matching of the extracted one or more features of the cropped face image with the set of data corresponding to the user.

In another aspect, the present disclosure provides a face recognition system for authenticating a user. The system includes an image capturing unit adapted to capture at least one image of the user. The system includes an analyzer module adapted to analyze the at least one captured image(s) of the user to detect a face corresponding to the pre-defined parameters being conformed. The system includes a cropping module adapted to crop out the detected face from the at least one captured image to form a cropped face image. The system includes an extraction module adapted to extract one or more features from the cropped face image. The system includes a comparing module adapted to compare the extracted one or more features of the cropped face image with a set of data associated with a plurality of users, wherein the set of data associated with the plurality of users is stored in one or more database repositories. The system includes an authentication module adapted to authenticate the user based on a positive matching of the extracted one or more features of the cropped face image with the set of data corresponding to the user.

The present invention proposes a novel approach of removing server dependency, network dependency, reducing cost, ensuring interoperability in facial recognition system even in case when the system is in an offline mode.

### BRIEF DESCRIPTION OF THE DRAWINGS

The accompanying drawing, which are incorporated herein, and constitute a part of this disclosure, illustrate exemplary embodiments of the disclosed method. Components in the drawing are not necessarily to scale, emphasis instead being placed upon clearly illustrating the principles of the present disclosure.

FIG. 1 illustrates components of a face recognition system [100] for authenticating a user.

FIG. 2 illustrates an exemplary method flow diagram [200] for authenticating the user via face recognition, in accordance with the exemplary embodiment of the present disclosure.

FIG. 3 illustrates an exemplary process for authenticating a user A via the face recognition system [100], in accordance with the exemplary embodiment of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A 6 process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a smart electronic device”, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a storage unit and any other such unit(s) which are required to implement the features of the present disclosure.

As discussed in the background section, there is problem of interoperability of the facial recognition system between two or more edge devices. Further, existing solutions do not provide a solution for the facial recognition system to address the challenge of working in offline mode due to network and server dependency. Further, the conventionally available systems violate privacy of the registered users because it exposes the users' data to curious service providers.

Thus, to overcome the drawbacks of the existing solutions, a method for authenticating the user via face recognition is disclosed that enables a face recognition system to work interoperably on one or more devices. The one or more devices include, but not limited to, server, edge devices, mobile devices, laptops, and/or computers. The face recognition system according to the present disclosure enables the user to get himself/herself/themselves to register on one edge device and get authenticated on another edge device. Further, the face recognition system, as per the present disclosure, generates a unique facial encoding for each of the plurality of users, such that this facial encoding generated on the server side as well as edge devices is same for an individual user. The facial recognition system allows the facial encoding to be saved in one or more data repositories such the one of the one or more database repositories can be installed on each of the one or more devices, which allows the facial recognition system to work interoperably on one or more devices. Further, the facial recognition system also enables the process of authentication to happen in the offline mode, for instance the user can mark his or her attendance on an offline device against the encoding stored on that offline device and when once internet connectivity is restored, the attendance log is synched to the server or other edge devices.

In an embodiment, the present disclosure utilizes computer vision and neural networks (or deep learning) that allows a more accurate and robust system for identifying the face of the plurality of users and respective relative information. The present invention utilizes a trained model that analyzes images of the user to successfully match against a set of image data of the plurality of users stored in one or more database repositories. The present disclosure, in order to avoid any bias in the dataset, involves training the model on a very large dataset comprising of different demographic locations, professions, age groups and sex. In an embodiment, the trained model is based on Machine learning, Artificial Intelligence by analyzing image of the user to successfully match against a set of image data of plurality of users stored in one or more database repositories.

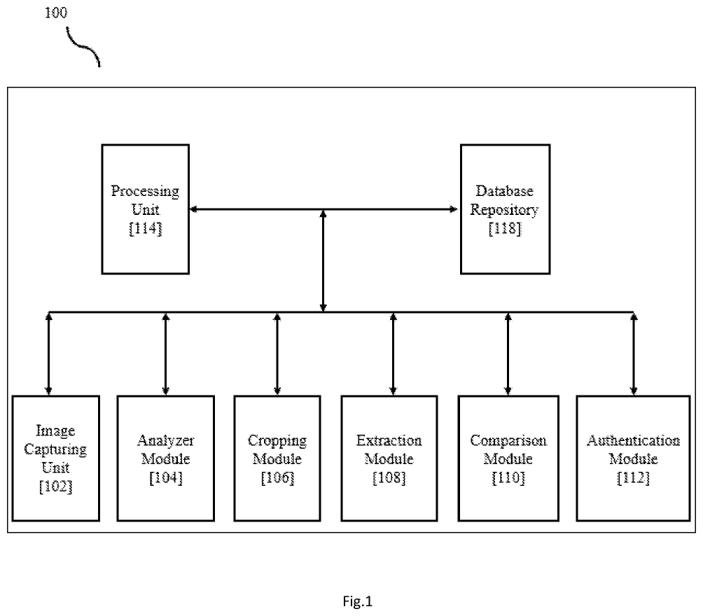

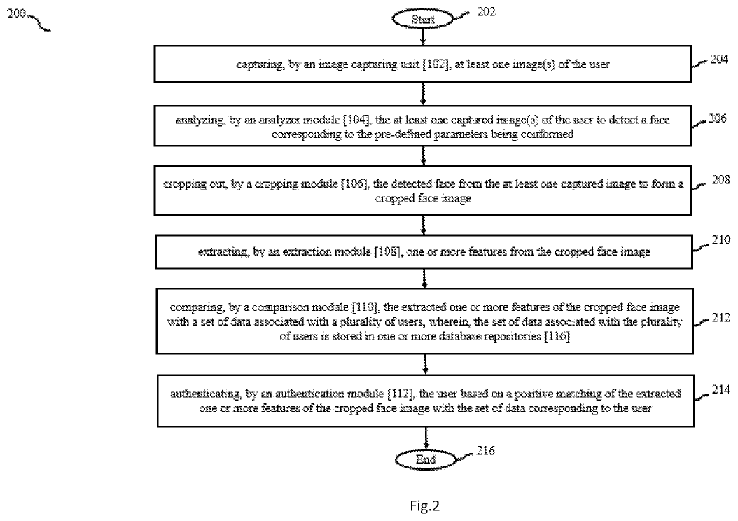

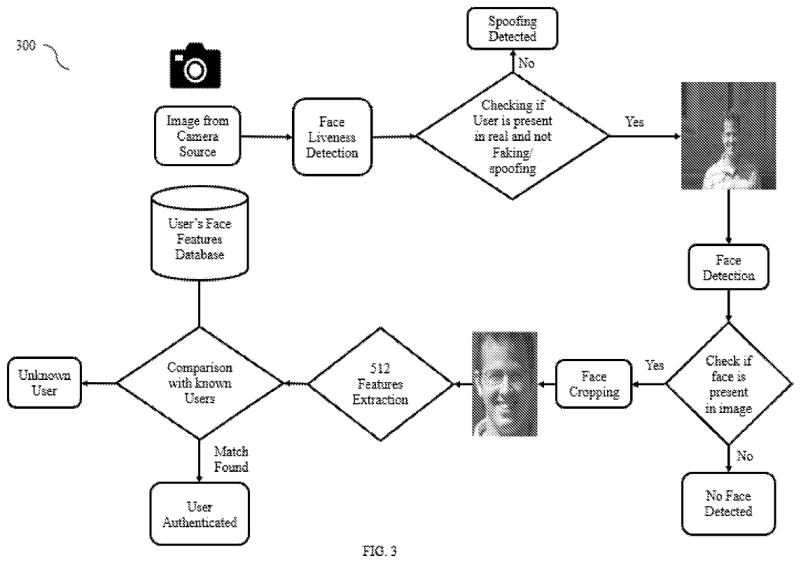

The present disclosure is further explained in detail below with reference to the diagrams FIG. 1, FIG. 2 and FIG. 3.

FIG. 1 illustrates components of a face recognition system [100] for authenticating a user. The present invention discloses a face recognition system [100] for authenticating a user, the system [100] comprises: an image capturing unit [102] adapted to capture at least one image of the user; an analyzer module [104] adapted to analyze the at least one captured image(s) of the user to detect a face corresponding to the pre-defined parameters being conformed. The face recognition system [100] further comprises a cropping module [106] that is adapted to crop out the detected face from the at least one captured image to form a cropped face image, an extraction module [108] adapted to extract one or more features from the cropped face image, a comparison module [110] adapted to compare the extracted one or more features of the cropped face image with a set of data associated with a plurality of users, wherein the set of data associated with the plurality of users is stored in one or more database repositories [116]; and an authentication module [112] adapted to authenticate the user based on a positive matching of the extracted one or more features of the cropped face image with the set of data corresponding to the user.

### Image Capturing Unit [102]

The image capturing unit [102] of the face recognition system [100] is adapted to capture at least one image(s) of the user. The image capturing unit is selected from a group of a digital camera, a smart-phone camera, a laptop camera, handheld scanner type camera, biometric scanning device, and the like. The image capturing unit [102] is further connected to an analyzer module [104] for analyzation of the captured image.

### Analyzer Module [104]

The analyzer module [104] of the face recognition system [100] is adapted to analyze the at least one captured image(s) of the user to detect a face corresponding to pre-defined parameters. The pre-defined parameters at the step of analyzing the at least one captured image(s) of the user includes verifying realness (liveness) or fakeness (non-live, fabricated or synthetic) of the at least one captured image(s) of the user. The analyzer module [104] is further connected to the cropping module [106].

### Cropping Module [106]

The cropping module [106] receives the captured image of the user after analyzation by the analyzer module [104]. The cropping module [106] is adapted to crop out the detected face from the at least one captured image to form a cropped face image. The cropping module [106] is further connected to an extraction module [108] and the cropped face image is shared to the extraction module [108].

### Extraction Module [108]

The extraction module [108] is adapted to extract one or more features from the cropped face image received from the cropping module [106]. The extracted one or more features from the cropped face image are later utilized to check the authentication of the user. The extraction module [108] is further connected to one or more data repositories [116], for storing the cropped face images of the one or more of users, to form the set of data associated with the plurality of users, at the time of registration of the new user. The extraction module [108] extracts one or more features from the cropped face image, at the time of new user authentication, and sends it to the comparison module [110]. In an embodiment, the extraction module [108] is adapted to, preferably, extract 512 features from the cropped image.

### One or More Database Repositories [116]

The one or more database repositories [116] are adapted to store a set of data of the plurality of users, wherein the set of data includes pre-store face images of the plurality of users along with pre-defined associated parameters of the user(s) including, but not limited to, name, date of birth, race, ethnicity, region and/or designation, prior to the authentication of the user via face recognition. In order to

pre-store the set of data of the plurality of users, the face recognition system [100] utilizes the image capturing unit [102], the analyzer module [104], the cropping module [106] and the extraction module [108] to create the set of data of the plurality of users. The one or more database repositories [116] can be located on one or more devices or servers to enable interoperability of the facial recognition system [100].

### Comparison Module [110]

The comparison module [110] is adapted to compare the extracted one or more features of the cropped face image with the set of data associated with pre-store face images of the plurality of users, wherein the set of data associated with the plurality of users is stored in one or more database repositories [116]. The comparison module [110] is further connected with an authentication module [112].

### Authentication Module [112]

The authentication module [112] is adapted to authenticate the user based on a positive matching of the extracted one or more features of the cropped face image with the set of data corresponding to the user. The authentication of the user via face recognition is performed interoperably by utilizing the one or more database repositories [116] located at the one or more devices. In an event of negative matching of the extracted one or more features of the cropped face image with the set of data associated with the plurality of users is stored in one or more database repositories [116], the authentication module [112] is adapted to reject the authentication of the user.

FIG. 2 illustrates an exemplary method flow diagram [200] for authenticating the user via face recognition, in accordance with the exemplary embodiment of the present disclosure. As shown in FIG. 2, the method starts at step [202].

At step [204], the method comprises capturing, by the image capturing unit [102], the at least one image(s) of the user to form at least one captured image(s). This the at least one captured image(s) is shared to the analyzer module [104] for performing the next step of authentication.

Next at step [206], the method comprises analyzing, by the analyzer module [104], the at least one captured image(s) of the user to detect a face of the user corresponding to the pre-defined parameters being conformed. The pre-defined parameters for analyzing the at least one captured image(s) of the user includes verifying realness (liveness) or fakeness (non-live, fabricated or synthetic) of the at least one captured image(s) of the user. If the analyzer module [104] detects that the at least one captured image(s) of the user is fake, the process of authentication of the user gets terminated. Once the analyzer module [104] detects that the at least one captured image(s) of the user is real, the analyzer module [104] proceeds to detect the face of the user. In a non-limiting embodiment, the face images of the plurality of users along with pre-defined associated parameters of the user(s) includes, but not limited to, name, date of birth, race, ethnicity, region and/or designation are pre-stored in the one or more database repositories [116] prior to the authentication of the user via face recognition.

Next at step [208], the method comprises cropping out, by the cropping module [106], the detected face from the at least one captured image to form the cropped face image. This cropped image contains the detected face from the at least one captured image which is cropped out by the cropping module [106] to form a cropped face image. This cropped face image of the user is shared to the extraction module [108] for performing the next step of authentication.

Next at step [210], the method comprises extracting, by the extraction module [108], the one or more features from the cropped face image. These extracted one or more features from the cropped face image are later used by the comparison module [110] for performing the next step of authentication.

The process of storage of the set of data associated with a plurality of users is stored in one or more database repositories [116] are described herein below:

The above-mentioned steps [204], [206], [208], and [210] are utilized in a similar manner, as disclosed above, for the purpose of pre-storing the set of data associated with the plurality of users in the one or more database repositories [116]. For this purpose, once the step [210] is performed, a step of storage of the set of data associated with the plurality of users is performed by a processing unit [116]. The set of data described herein contains previously stored facial features of registered users. Further, the extracted one or more features from the cropped face images of the plurality of users are stored at the one or more database repositories [116], to form the set of data associated with the plurality of users. In an embodiment of the present invention, the one or more database repositories [116] are located at one or more devices including, but not limited to, server, edge devices, mobile devices, laptops, and/or computers. The authentication of the user via face recognition is performed interoperably over one or more devices by utilizing the one or more database repositories [116] located at the one or more devices.

Next at step [212], the method comprises comparing, by the comparison module [110], the extracted one or more features of the cropped face image with the set of data associated with the plurality of users, wherein, the set of data associated with the plurality of users is stored in the one or more database repositories [116]. This comparison is later used by the authentication module [110] for performing the next step of authentication.

Next at step [214], the method comprises authenticating, by the authentication module [112], the user based on a positive matching of the extracted one or more features of the cropped face image with the set of data corresponding to the user. the user is authenticated based on a positive matching of the extracted one or more features of the cropped face image with the set of data corresponding to the user, by an authentication module [112]. The authentication of the user via face recognition is performed interoperable by utilizing the one or more database repositories [116] located at the one or more devices. In an event of negative matching of the extracted one or more features of the cropped face image with the set of data associated with the plurality of users is stored in one or more database repositories [116], the authentication module [112] is adapted to reject the authentication of the user.

Lastly, the method stops at step [216].

In an embodiment, each of the Image Capturing Unit [102], analyzer module [104], the cropping module [106], the extraction module [108], the comparison module [110], the authentication module [112], and one or more Database repositories [116] are connected to the Processing Unit [114] such that the Processing Unit [114]

enables of the aforementioned components to perform their designated functions as disclosed in the present disclosure.

In an embodiment, the authentication of the user via face recognition is performed in an online mode such that the one or more devices are in a proper internet connection with each other to perform the method [200] for authenticating the user via face recognition.

In another embodiment, the authentication of the user via face recognition is performed in an offline mode, such that the offline mode for the authentication of the user includes a local computation & Artificial Intelligence (AI) processing of the face recognition without any dependency of internet and then data synchronization between the one or more devices and server once internet connectivity is restored.

In an exemplary embodiment, the trained model is trained using an enormous dataset associated with the plurality of users of different demographic locations, professions, age groups and gender. The trained model then relies on tuning and optimization of the facial image of the plurality of users received on the one or more database repositories [116]. The facial image(s) is further quantized and subjected to model Compression and the facial features so captured and extracted are then simultaneously stored over the data repository [116] of the server and the edge devices.

FIG. 3 illustrates an exemplary block diagram to illustrate the method [200] for authenticating a user via face recognition, in accordance with exemplary embodiment of the present disclosure. Initially, an image of a user A is captured by a camera source. This captured image is then subjected to analyzation of the at least one captured image(s) of the user to detect a face corresponding to pre-defined parameters. The pre-defined parameters at the step of analyzing the at least one captured image(s) of the user includes checking Face Liveness Detection that includes checking if there is realness or fakeness/spoofing of the at least one captured image(s) of the user. If fakeness/spoofing is detected, then no further action is taken by the system [100] and the authentication is terminated. On the other hand, if realness is detected, then the captured image is subjected to analysis to detect the face of the user. The cropping of the detected face, from the at least one captured image, is performed by the cropping module [106] to form the cropped face image. The cropped image is subjected to extraction of the one or more features, preferably 512 features, by the extraction module [108]. The extracted one or more features are then compared with the set of data saved in the one or more data repositories [116]. Based on a positive matching, the user A is authenticated, and in case of negative matching, the user A is not authenticated. In another non-limiting example, the number of face features may vary as per the trained model.

In an example of the present invention, User X is a male user and wants to enter into a place secured with a face recognition system [100]. The image capturing unit [102] of the face recognition system [100] will first capture the image of the User X to check if User X is a genuine user or not. In a first case, User X may show a video or image of any User Y for the recognition purpose, however the face recognition system [100] is designed in such a way that it can detect the fake entry and allow the entry of genuine users.

In a second case, the camera of the face recognition system [100] captures the image of User X and then analyses the face of the user based on pre-defined parameters and crops out the face using cropping techniques. After cropping the face of the User X, the authentication system extracts a plurality of face features of the user X to compare the features from the one or more database repositories [116] (of a plurality of users). In case, the extracted features of the user X successfully matched within the one or more stored database repository [116] associated with a plurality of user, the authentication system [100] authenticates the user X and then the User X can enter into the place.

In another example, the present invention of face recognition system is installed on an edge device for authenticating students of a school located in a geographical area with low internet connectivity. In such case, each of the one or more devices have a data repository [116] installed to allow the authentication of the students for the purpose of attendance. The data associated with the authentication of the students is stored on the edge devices and can be synchronized with the server as soon as the edge device gets in connection with nearby internet. Thus, the present authentication system is adaptive and can be deployed on the edge devices as well as on the server to reduce the dependency on the internet.

The present invention, further, in another embodiment the analyzer module [104] uses the model Retina Face to detect the face out of an image. In another embodiment, utilizes RESNET Architecture with 101 layers along with ARCFACE as a loss function to achieve results with better accuracy as compared to the existing solutions. In such embodiment, the RESNET Architecture adds an extra hidden layer where neurons are equivalent to number of users at the time of training. Once the training is completed with above combination, the last layer is removed and final model is saved and added to generate the face encoding.

In another embodiment of the present invention, the comparison module [110] for generating a similarity score while comparing of the features as disclosed above, utilizes a cosine similarity using the dot product.

In yet another embodiment, the trained model utilizes Additive Angular Margin Loss to train deep neural network (DNN) models for face recognition to improve the discriminative power of the face recognition system [100] and achieve a stabilized training process. In such embodiment, arc-cosine function is utilized to calculate an angle between the current feature and a target weight. Then after, arc-cosine function adds an additive angular margin to the target angle to get the target logic back again by the arc-cosine functions. Further this embodiment re-scales all logics by a fixed feature norm, and the subsequent steps are the same as in the SoftMax loss. This way the present embodiment that utilizes the Additive Angular Margin Loss surpassed the accuracy achieved by existing systems such as triplet and SoftMax loss.

As evident from the above disclosure, the present invention provides significant technical advancement over the existing solutions. The present disclosure is advanced over the techniques present in the prior art in view of the following aspects.
a) The present invention generates the same facial encoding on the server side as well as edge devices making the technology interoperable on different edge devices.
b) The encoding is same on different devices unlike the existing technology making the technology interoperable and enables the authentication to happen in the offline mode.
c) The present invention improves the discriminative power of the face recognition model and stabilizes the deep neural network training process for face recognition.
d) Internet dependency is not required for face recognition enabling the present invention to be deployed in regions of low or no Internet connectivity.
e) The present invention is deployed or integrated on the edge device which reduces the cost of face recognition effectively.
f) Unlike existing technology that deploys AI Models over the cloud server, the present invention also deploys AI Model on the edge devices i.e., Android devices, iOS Devices thus reducing internet dependency as well as the server cost.

While considerable emphasis has been placed on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

I/we claim:

1. A method for authenticating a user via face recognition, the method [200] comprising:
capturing, by an image capturing unit [102], at least one image of the user;
analyzing, by an analyzer module [104], the at least one captured image(s) of the user to detect a face corresponding to the pre-defined parameters being conformed;
cropping out, by a cropping module [106], the detected face from the at least one captured image to form a cropped face image;
extracting, by an extraction module [108], one or more features from the cropped face image;
comparing, by a comparing module [110], the extracted one or more features of the cropped face image with a set of data associated with a plurality of users,
wherein the set of data associated with the plurality of users is stored in one or more database repositories [120]; and
authenticating, by an authentication module [114], the user based on a positive matching of the extracted one or more features of the cropped face image with the set of data corresponding to the user.

2. The method [200] as claimed in claim 1, wherein the pre-defined parameters at the step of analyzing the at least one captured image(s) of the user includes verifying realness (liveness) or fakeness (non-live, fabricated or synthetic) of the at least one captured image(s) of the user.

3. The method [200] as claimed in claim 1, wherein authenticating the user via face recognition is performed inter-operably by utilizing the one or more database repositories [120] located at the one or more devices or servers.

4. The method [200] as claimed in claim 1, wherein the set of data contains previously stored facial features of registered users.

5. The method [200] as claimed in claim 1, wherein the authentication of the user via face recognition is performed in an online mode and offline mode, such that the offline mode for the authentication of the user includes a local computation & Artificial Intelligence (AI) processing of the face recognition without any dependency of internet and then data synchronization between the one or more devices and server once internet connectivity is restored.

6. The method [100] as claimed in claim 1, wherein face images of the one or more users along with pre-defined associated parameters of the user(s) are pre-stored in the one or more database repositories [120] prior to the authentication of the user via face recognition.

7. The method [100] as claimed in claim 1, wherein the set of data associated with the plurality of users is stored by:
capturing, by the image capturing unit [102], at least one image of each of the plurality of users;
analyzing, by the analyzer module [104], the at least one captured image(s) of each of the plurality of users to detect face(s) corresponding to the pre-defined parameters being conformed;
cropping out, by the cropping module [106], the detected face(s) from the at least one captured image to form the cropped face images;
extracting, by an extraction module [108], one or more features from the cropped face images of each of the plurality of users; and
storing, at the one or more database repositories [120], the extracted one or more features from the cropped face images of the plurality of users to form the set of data associated with the plurality of users.

8. The method [200] as claimed in claim 1, wherein the one or more database repositories [120] are located at one or more devices including, but not limited to, server, edge devices, mobile devices, laptops, and/or computers.

9. A face recognition system [100] for authenticating a user, the system [100] comprising:
an image capturing unit [102] adapted to capture at least one image of the user;
an analyzer module [104] adapted to analyze the at least one captured image(s) of the user to detect a face corresponding to the pre-defined parameters being conformed;
a cropping module [106] adapted to crop out the detected face from the at least one captured image to form a cropped face image;
an extraction module [108] adapted to extract one or more features from the cropped face image;
a comparing module [110] adapted to compare the extracted one or more features of the cropped face image with a set of data associated with a plurality of users,
wherein the set of data associated with the plurality of users is stored in one or more database repositories [120]; and
an authentication module [112] adapted to authenticate the user based on a positive matching of the extracted one or more features of the cropped face image with the set of data corresponding to the user.

10. The system [100] as claimed in claim 9, wherein authentication of the user via face recognition is performed inter-operably by utilizing the one or more database repositories [120] located at the one or more devices or servers.

11. The system [100] as claimed in claim 9, wherein to store the set of data associated with the plurality of users,
the image capturing unit [102] adapted to capture at least one image of each of the plurality of users;
an analyzer module [104] adapted to analyze the at least one captured image(s) of each of the plurality of users to detect face(s) corresponding to the pre-defined parameters being conformed;
a cropping module [106] adapted to crop out the detected face(s) from the at least one captured image to form the cropped face images;
an extraction module [108] adapted to extract one or more features from the cropped face images of each of the plurality of users; and
the one or more database repositories [120] adapted to store the extracted one or more features from the cropped face images of the plurality of users to form the set of data associated with the plurality of users.
